(19) United States
(12) Patent Application Publication
(10) Pub. No.: US 2011/0087888 A1
(43) Pub. Date: Apr. 14, 2011

(54) AUTHENTICATION USING A WEAK HASH OF USER CREDENTIALS

(75) Inventor: Jeffrey Rennie, Mountain View, CA (US)

(73) Assignee: GOOGLE INC., Mountain View, CA (US)

(21) Appl. No.: 12/752,562

(22) Filed: Apr. 1, 2010

Related U.S. Application Data
(60) Provisional application No. 61/251,292, filed on Oct. 13, 2009.

(51) Int. Cl. G06F 21/00

(52) U.S. Cl. 713/182

(57) ABSTRACT

Methods and apparatus for logging into a computer. The computer receives a username and password. The computer determines whether a user with the username is authorized to access the computer. If so, the computer retrieves a weak cryptographic hash of the user's password and compares it to a weak cryptographic hash of the received password. The computer grants access if the weak cryptographic hashes are identical, and sends the username and password to a server. The server determines whether a user with the username has a server account. If so, the server retrieves a strong cryptographic hash of the user's password and compares it to a strong cryptographic hash of the received password. The server grants the user access to an account or service if the strong cryptographic hashes are identical.

### CROSS REFERENCE TO RELATED APPLICATIONS

This application claims the benefit of U.S. Provisional Application No. 61/251,292, filed Oct. 13, 2009, and titled “Account and Boot Management in a Cloud Computing Platform,” which is incorporated herein by reference in its entirety.

### TECHNICAL FIELD

This document relates to computer security and to methods of authenticating a computer user using a weak hash of a user authentication credential.

### BACKGROUND

With the creation of the world-wide-web and high speed computer networks, the paradigm for personal computer usage has dramatically shifted. In the past, users would primarily use their personal computers to run programs, and store and manipulate data that was located on their local hard-drive. Only rarely would users store or manipulate data located on a networked drive, or run a program that was provided as a network service, and even then, the programs and data were usually restricted to a local area network. Today, more and more users are storing more and more data on remote data servers, and using remotely provided web-based applications (e.g., SaaS or Software as a Service programs) to manipulate and organize that data. For example, many users today store their personal email and contact information, and even pictures, videos, and music archives on remote servers, and access that data using third party applications that are provided through and controlled by a web-browser.

Cloud computing is a style of computing in which computing resources such as application programs and file storage are remotely provided over the Internet, typically through a web browser. Many web browsers are capable of running applications (e.g., Java applets), which can themselves be application programming interfaces (“API's”) to more sophisticated applications running on remote servers. In the cloud computing paradigm, a web browser interfaces with and controls an application program that is running on a remote server. Through the browser, the user can create, edit, save and delete files on the remote server via the remote application program.

Due to this shift in computer usage, today's computer users are unlikely to want or need many of the bells and whistles provided by modern operating systems. They do not need to worry about file structures or organizing or backing up their data, because much of their data is stored, organized and backed up for them on the cloud. They do not need to worry about loading and updating software, because most of the software they use is provided to them when needed as a cloud-based service. Instead, today's computer users are more interested in quickly logging onto their computer, launching a web browser, and logging into a cloud based server to access data and programs available to them through a cloud based service.

In most computer systems, logging onto the computer requires a user to enter his or her username and password. The computer receives the username and password, computes a strong cryptographic hash of the password, and looks for a record in a local authentication database that relates the received username to the strong cryptographic hash of the received password. If the computer finds such a record, it can authenticate the user and grant the user access to one or more of the computer's resources. A strong cryptographic hash is a cryptographic function that maps each unique input value to a nearly unique output or hash value. Storing strong cryptographic hashes of user passwords in user authentication databases provides a certain level of security to password protected computer user accounts. For example, a first user who accessed a computer could not easily gain access to a second user's account on the same computer by simply querying the authentication database for the second user's username and password. At best, such a query, even if successful, would only return the second user's username and a strong cryptographic hash of the second user's password. Unless the first user knew how to invert the strong cryptographic hash function, the first user would not likely be able to determine the second user's password, and so would not likely be able to access the second user's account.

Of course, if the first user were determined and had the resources, he or she could use brute force to try to invert the strong cryptographic hash function. The brute force method could work by exploiting the nearly one-to-one mapping between input values and output values of strong cryptographic hash functions. For example, using one or more dictionaries and one or more strong cryptographic hash functions, the first user could compute strong cryptographic hashes of the words in the dictionaries using the different hash functions until one or more words were found whose strong cryptographic hashes matched the strong cryptographic hash of the second user's password. The small number of matching words could then be used to determine the second user's password by trial and error before the computer recognized the second user's account was under attack. Of course, once the first user obtained the second user's password in this way, the first user could access the second user's account at will. Moreover, if the second user relied on the same username and password to protect other accounts, the first user would be able to easily access the second user's other accounts.

### SUMMARY

Methods and apparatus for logging into a computer optimized for cloud-based computing are disclosed. The computer may be a desktop, notebook or netbook computer, or a mobile device such as a personal digital assistant or smart phone. The computer receives a username and a password from a user and computes a weak cryptographic hash of the received password. The computer then determines whether a user with the received username is authorized to access the computer. If a user with the received username is authorized to access the computer, the computer retrieves a weak cryptographic hash of a password that is associated with the received username in the computer, and compares the weak cryptographic hash of the received password with the weak cryptographic hash of the associated password. The computer grants the user access to the computer if the weak cryptographic hash of the received password and the weak cryptographic hash of the associated password are identical.

Features and advantages of the disclosed method and apparatus include one or more of the following. The computer can determine whether a user with the received username is authorized to access the computer by querying a database for a record containing the received username and a weak cryptographic hash of a password that is associated with the received username. The computer can retrieve a weak cryptographic hash of a password that is associated with the received username from the database record.

The computer can send the received username and the received password to a remote server if the weak cryptographic hash of the received password and the weak cryptographic hash of the password that is associated with the username in the computer are identical.

### DESCRIPTION OF DRAWINGS

FIG. 1 is a flow chart showing a method for authenticating a user logging onto a computer using a weak cryptographic hash function.

FIG. 2 is a schematic diagram disclosing the exchange of authentication information between a computer platform and a cloud-based server offering a cloud-based service.

FIG. 3 is a flow chart showing a method for authenticating a user logging onto a cloud-based server using a strong cryptographic hash function.

Like reference symbols in the various drawings indicate like elements.

### DETAILED DESCRIPTION

A cloud optimized computer is a computer configured to operate in a cloud computing environment, such as a computer running the ChromeOS operating system available from Google Inc. A cloud optimized computer can be configured to allow a user to log onto one or more remote cloud based servers using a single sign-on procedure. This can be done, for example, by using the same username and password that is needed to access the cloud optimized computer to access the one or more remote cloud-based servers or services. To log onto the cloud optimized computer, the user can enter a username and password. The cloud optimized computer can verify the username and password, and upon doing so, can send the username and password to one or more remote cloud based servers. Each of the cloud based servers can subsequently verify the username and password in its own authentication database to grant the user access to the server and whatever cloud based services are provided on or through the server.

As discussed above, most computers today provide some level of user account security by storing usernames and strong cryptographic hashes of user passwords in their user authentication databases. However, as discussed above, the security thus provided can be overcome by a determined adversary who has the time and resources to subject the authentication database to a dictionary attack. Such an attack could effectively invert the strong cryptographic hash function, and allow the adversary to determine the passwords whose strong cryptographic hash values are stored in the authentication database. Once in possession of a user's username and password, the adversary could log onto and access the user's local computer. Moreover, if the local computer provided a single sign-on service to automatically log the user onto one or more cloud based accounts or services, the adversary could also log onto the user's cloud based services and accounts.

To better secure a user's cloud-based accounts and services, a cloud optimized computer can store weak cryptographic hashes of user passwords in its authentication database rather than strong cryptographic hashes of user passwords. A weak cryptographic hash is a function that maps a large number of unique input values to the same output or hash value. The large number-to-one mapping of weak cryptographic hash functions makes storing weak cryptographic hashes of user passwords advantageous to storing strong cryptographic hashes of user passwords. This is because even after a successful dictionary attack, an adversary would not be able to uniquely determine the passwords whose weak cryptographic hashes are stored in a computer's authentication database. For example, since many different words from a dictionary (e.g., apple, apples and applet) can map to the same weak cryptographic hash value, inverting the weak cryptographic hash function that generated that hash value would reveal not just a few, but rather a very large number of possible input words. In one implementation, the weak hash function can map tens of thousands or even hundreds of thousands of unique passwords to the same cryptographic hash value. Thus, even after a successful dictionary attack, an adversary would only know that the user's password is one of among tens or hundreds of thousands of possible passwords that map to the same weak cryptographic hash value. To access the user's cloud based accounts and services, the adversary would still need to determine the user's actual password from among the tens or hundreds of thousands of possible passwords.

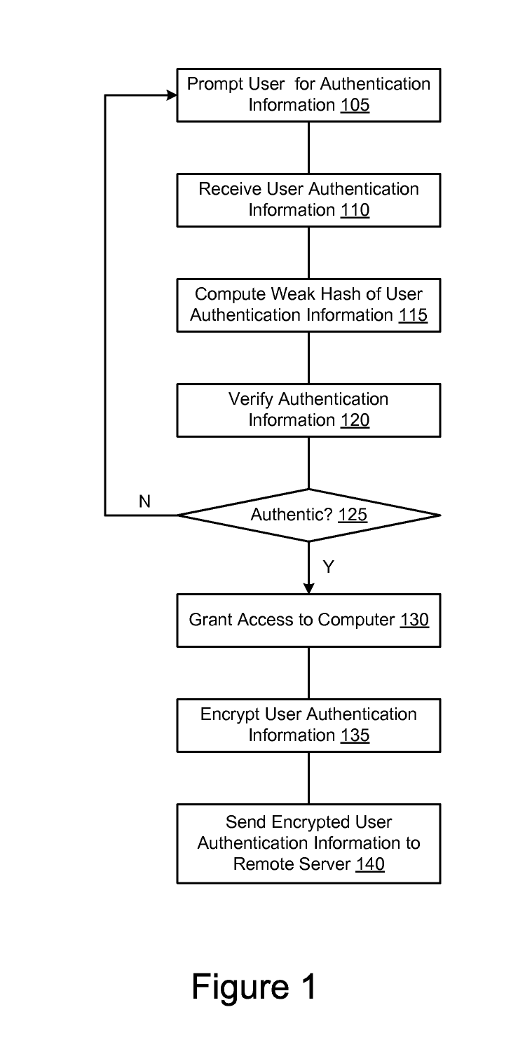

FIG. 1 is a flow chart showing a method for authenticating a user logging onto a computer using a weak cryptographic hash function. As shown in FIG. 1, the computer can prompt a user to enter authentication information (105). In one implementation, the authentication information can be a username and password, and the computer can prompt the user to enter the authentication information by providing a login screen. Once the username and password are entered into the login screen, the computer can receive the authentication information (110), and verify it. In one implementation, the computer can verify the received authentication information by searching a local authentication database (i.e., a database that is local to the computer). The local authentication database can store usernames and weak cryptographic hashes of associated user passwords for all authorized users of the computer. In this implementation, the computer can compute a weak cryptographic hash of the received password (115) in order to verify the authentication information (120). The computer can query the local authentication database for the received username. If the query returns a database record that contains the received username and a weak cryptographic hash of the user's password, the computer can retrieve the weak cryptographic hash of the user's password and compare it to the weak cryptographic hash of the received password. If the two hash values differ (125), the authentication fails, and the computer can once again prompt the user to enter his or her authentication information (105). In some implementations, the computer can limit the number of login attempts, and can prevent a user from accessing the computer after a given number of failed login attempts. In other implementations, the computer can grant the user limited access rights even after the user has failed authentication. Such limited access rights can be, for example, only the right to browse information on the World Wide Web.

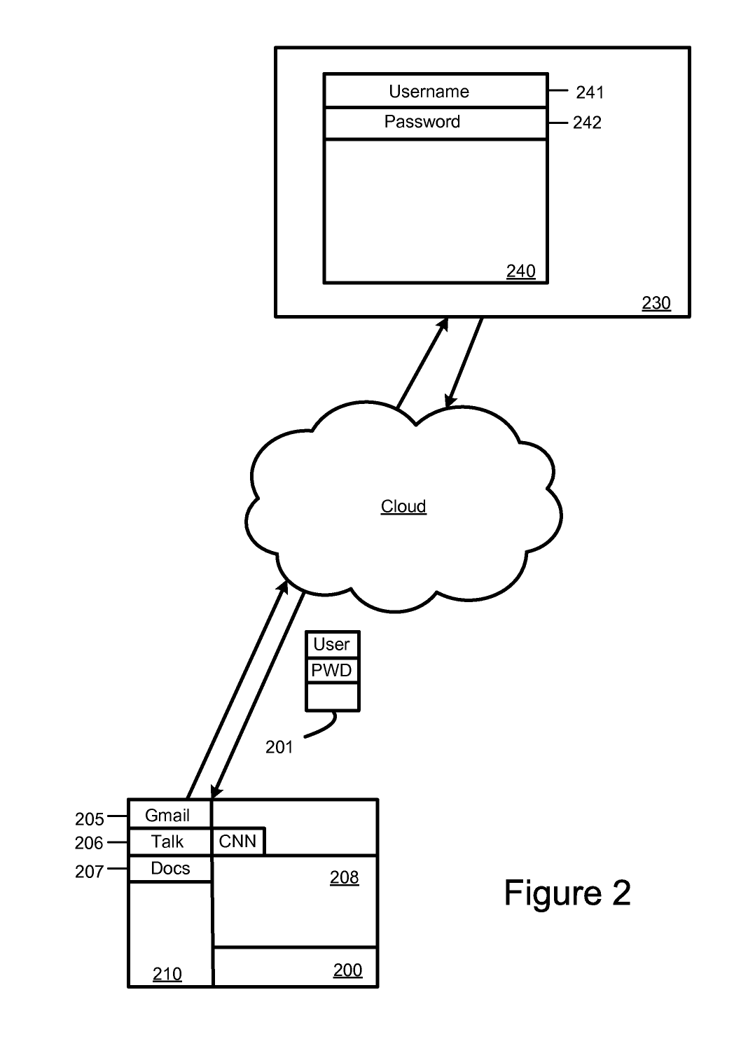

Referring again to FIG. 1, if the weak cryptographic hash of the received password is identical to the weak cryptographic hash of the user's password that is stored in the local authentication database (125), the computer can grant the user access to the computer (130). In one implementation, the computer can then encrypt the received authentication information (135), and send the encrypted authentication information to one or more remote servers that offer one or more remote cloud based services (140). Each of the remote servers that receive the encrypted authentication information can then use it to grant or deny the user access to the remote server or to a cloud-based account or service that is offered on through the remote server. In one implementation, the remote server includes an authentication database that stores usernames and strong cryptographic hashes of user passwords for all authorized users. In this implementation, a malicious user who was able to successfully attack the computer's local authentication database in order to access the user's local computer account would nonetheless be unable to access the user's cloud-based accounts or services. For, as described above, a large number of words would map to the weak cryptographic hash of the user's password that is stored in the computer's local authentication database. Thus, after a successful attack of the local authentication database, a malicious user would at best be able to determine a large number of possible user passwords. While any one of these possible user passwords would allow the malicious user to access the user's account on the local computer, the malicious user would only be able to access the user's account on the remote server if the malicious user knew the user's actual password. To determine the actual password, the malicious user would need to try a large number of username/password combinations to determine that combination that granted access to the user's account on the remote server. The remote server could easily detect that the user's account was under attack after several failed authorization attempts, and could deny the malicious user access to the user's cloud based account or disable the account altogether. This is illustrated more fully below in reference to FIG. 2.

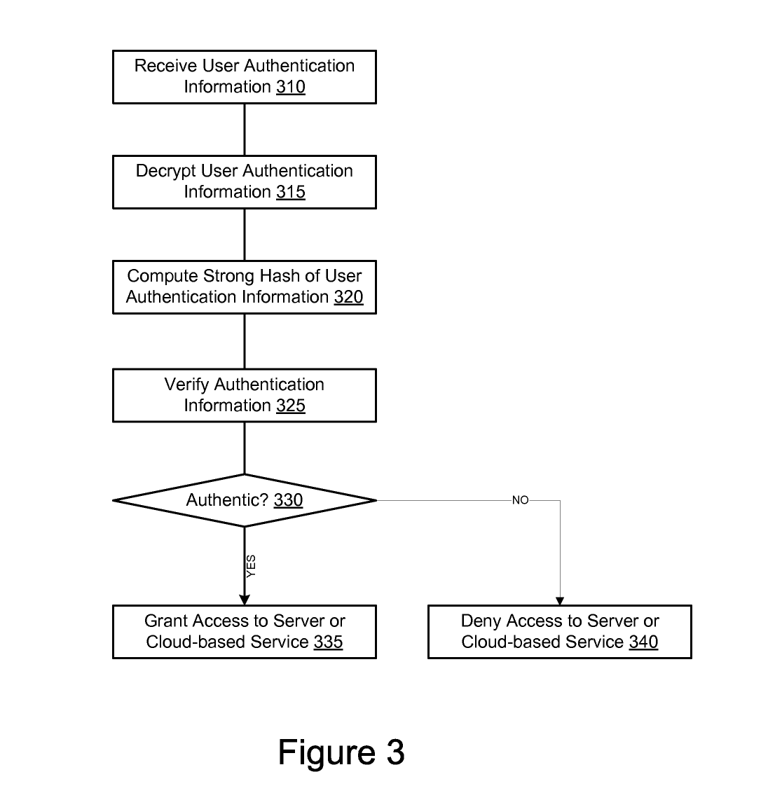

FIG. 2 is a schematic diagram disclosing the exchange of authentication information between a computer and a cloud-based server offering a cloud-based service. As discussed above, in one implementation when a user supplies authorization credentials to computer 200, the computer can use those credentials to automatically login or authenticate the user to the remote cloud-based server 230. For example, when a user successfully logs onto computer 200, the computer can send the authentication information 201 to the remote server 230 to authenticate the user at the remote server 230. In one implementation, the computer 200 encrypts this authentication information prior to sending it to remote server 230. The remote server 230 can include a remote authentication database 240 that stores information such as usernames 241 and passwords 242 for a plurality of authorized users. The remote server 230 can verify the authentication information 201 sent by computer 200 after decrypting it. In one implementation, remote server 230 stores usernames 241 and weak cryptographic hashes 242 of user passwords in remote authentication database 240. In this implementation, the remote server can verify the decrypted username and password in the same way cloud optimized computer 200 can verify received usernames and passwords as discussed above in reference to FIG. 1. In another implementation, remote server 230 can store usernames 241 and strong cryptographic hashes 242 of user passwords in authentication database 240. In this implementation, the remote server 230 can verify the decrypted username and password as shown in FIG. 3.

FIG. 3 is a flow chart showing a method for authenticating a user logging onto a cloud-based server using a strong cryptographic hash function. As shown in FIG. 3, the remote server 230 can receive user authentication information (310), decrypt the authentication information (315), and then compute a strong cryptographic hash of the received and decrypted authentication information (320). The remote server 230 can then verify the authentication information (325). In one embodiment, the authentication information consists of a username and password. The remote server 230 receives the username and password (310), decrypts the username and password (315) and computes a strong cryptographic hash of the received and decrypted password (325). To verify the authentication information (325), the remote server 230 can query the remote authentication database 240 for the received and decrypted username. If the query returns a database record that contains the received and decrypted username and a strong cryptographic hash of the user's password, the computer can retrieve the strong cryptographic hash of the user's password and compare it to the strong cryptographic hash of the received and decrypted password. If the two hash values differ (330), the authentication fails, and the remote server 230 can deny the user access to the remote server 230 or to a cloud-based service or account that is offered on or through the remote server (340). However, if the two strong hash values are the same (330), the remote server 230 can grant the user access to the remote server or to a cloud-based service or account that is offered on or through the remote server (335).

The methods described herein may be implemented in digital electronic circuitry, or in computer hardware, firmware, software, or in combinations of them. The methods may be implemented as a computer program product, i.e., as a computer program tangibly embodied in a machine-readable storage device for execution by, or to control the operation of, a data processing apparatus such as a programmable processor, a computer, or multiple computers. A computer program can be written in any form of programming language, including a compiled or interpreted language, and can be deployed in any form, including as a stand-alone program or as a module, component, subroutine, plug-in or other unit suitable for use in a computing environment. A computer program can be deployed to be executed on one computer or on multiple computers at one site or distributed across multiple sites and interconnected by a communications network.

Processors suitable for the execution of a computer program include, by way of example, both general and special purpose microprocessors, and any one or more processors of any kind of digital computer, including digital signal processors. Generally, a processor will receive instructions and data from a read-only memory or a random access memory or both. Elements of a computer may include at least one processor for executing instructions and one or more memory devices for storing instructions and data. Generally, a computer may also include, or be operatively coupled to receive data from and/or transfer data to one or more mass storage devices for storing data, e.g., magnetic, magneto-optical disks, or optical disks.

Machine readable media suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry such as a FPGA (field programmable gate array) or as an ASIC (application-specific integrated circuit).

To provide for user interaction, the computer may include a display device, e.g., a cathode ray tube (CRT) or liquid crystal display (LCD) monitor, for displaying information to the user and a keyboard and a pointing device, e.g., a mouse, trackball or touch pad, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed apparatus and methods may be implemented on a computing system that includes a back-end component, e.g., a data server, or that includes a middleware component, e.g., an application server, or that includes a front-end component, e.g., a client computer having a graphical user interface or a Web browser through which a user can interact with any combination of such back-end, middleware, or front-end components. Components may be interconnected by any form or medium of digital data communication, e.g., a communication network, including a local area network (LAN) and a wide area network (WAN) such as the Internet.

A number of implementations of the invention have been described above. Nevertheless, it will be understood that various modifications may be made without departing from the spirit and scope of the invention. For example, the logic flows depicted in the figures do not necessarily require the particular order shown, or sequential order, to achieve desirable results. In addition, other steps may be provided or eliminated from the described flows, and other components may be added to or removed from the described systems, without departing from the scope of the invention. Accordingly, other implementations are within the scope of the following claims.

What is claimed is:

1. A computer implemented method for granting a user access to a computer, comprising:
receiving authentication information from the user;
computing a weak cryptographic hash of the received authentication information;
retrieving a weak cryptographic hash of authentication information that is stored in the computer;
comparing the weak cryptographic hash of the received authentication information with the weak cryptographic hash of the authentication information that is stored in the computer; and
granting the user access to the computer if the weak cryptographic hash of the received authentication information and the weak cryptographic hash of the authentication information that is stored in the computer are identical;
wherein the preceding steps are performed on the computer.

2. The computer implemented method of claim 1, further comprising sending the received authentication information to a remote server if the weak cryptographic hash of the received authentication information and the weak cryptographic hash of the authentication information that is stored in the computer are identical.

3. The computer implemented method of claim 1, wherein receiving authentication information comprises receiving a username and password and computing a weak cryptographic hash of the received authentication information comprises computing a weak cryptographic hash of the received password.

4. The computer implemented method of claim 3, wherein retrieving a weak cryptographic hash of authentication information stored in the computer comprises determining whether a user with the received username is authorized to access the computer, and if so, retrieving a weak cryptographic hash of a password that is associated with the received username.

5. The computer implemented method of claim 4, wherein determining whether a user with the received username is authorized to access the computer comprises querying a database for a record containing the received username and a weak cryptographic hash of a password that is associated with the received username.

6. The computer implemented method of claim 4, wherein retrieving a weak cryptographic hash of a password that is associated with the received username in the computer comprises retrieving the weak cryptographic hash of the associated password from the database record.

7. The computer implemented method of claim 3, wherein granting the user access to the computer if the weak cryptographic hash of the received authentication information and the weak cryptographic hash of the authentication information that is stored in the computer are identical comprises granting the user access to the computer if the weak cryptographic hash of the received password and the weak cryptographic hash of the associated password are identical

8. The computer implemented method of claim 7, further comprising sending the received username and the received password to a remote server if the weak cryptographic hash of the received password and the weak cryptographic hash of the associated password are identical.

9. A computer, comprising a processor configured to:
receive authentication information from a user;
compute a weak cryptographic hash of the received authentication information;
retrieve a weak cryptographic hash of authentication information that is stored in the computer;
compare the weak cryptographic hash of the received authentication information with the weak cryptographic hash of the authentication information that is stored in the computer; and
grant the user access to the computer if the weak cryptographic hash of the received authentication information and the weak cryptographic hash of the authentication information that is stored in the computer are identical.

10. The computer of claim 9, wherein the processor is further configured to send the received authentication information to a remote server if the weak cryptographic hash of the received authentication information and the weak cryptographic hash of the authentication information that is stored in the computer are identical.

11. The computer of claim 9, wherein a processor configured to receive authentication information comprises a processor configured to receive a username and password, and a processor configured to compute a weak cryptographic hash of the received authentication information comprises a processor configured to compute a weak cryptographic hash of the received password.

12. The computer of claim 11, wherein a processor configured to retrieve a weak cryptographic hash of authentication information that is stored in the computer comprises a processor configured to determine whether a user with the received username is authorized to access the computer, and if so, to retrieve a weak cryptographic hash of a password that is associated with the received username.

13. The computer of claim 12, wherein a processor configured to determine whether the user is authorized to access the computer comprises a processor configured to query a database for a record containing the received username and a weak cryptographic hash of a password that is associated with the received username.

14. The computer of claim 12, wherein a processor configured to retrieve a weak cryptographic hash of a password that is associated with the received username in the computer comprises a processor configured to retrieve the weak cryptographic hash of the associated password from the database record.

15. The computer of claim 11, wherein a processor configured to grant the user access to the computer if the weak cryptographic hash of the received authentication information and the weak cryptographic hash of the authentication information that is stored in the computer are identical comprises a processor configured to grant the user access to the computer if the weak cryptographic hash of the received password and the weak cryptographic hash of the associated password are identical.

16. The computer of claim 15, wherein the processor is further configured to send the received username and the received password to a remote server if the weak cryptographic hash of the received password and the weak cryptographic hash of the associated password are identical.

17. A computer program product, embedded on a computer readable medium, comprising instructions operable to cause a programmable processor to:
receive authentication information from a user;
compute a weak cryptographic hash of the received authentication information;
retrieve a weak cryptographic hash of authentication information that is stored in the computer;
compare the weak cryptographic hash of the received authentication information with the weak cryptographic hash of the authentication information that is stored in the computer; and
grant the user access to the computer if the weak cryptographic hash of the received authentication information and the weak cryptographic hash of the authentication information that is stored in the computer are identical.

18. The computer program product of claim 17, further comprising an instruction operable to cause a programmable processor to send the received authentication information password to a remote server if the weak cryptographic hash of the received authentication information and the weak cryptographic hash of the authentication information that is stored in the computer are identical.

19. The computer program product of claim 17, wherein the instruction to receive authentication information comprises instructions to receive a username and password, and wherein the instruction to compute a weak cryptographic hash of the received authentication information comprises an instruction to compute a weak cryptographic hash of the received password.

20. The computer program product of claim 19, wherein the instruction to retrieve a weak cryptographic hash of authentication information that is stored in the computer comprises an instruction to determine whether a user with the received username is authorized to access the computer, and if so, to retrieve a weak cryptographic hash of a password that is associated with the received username.

21. The computer program product of claim 20, wherein the instruction to determine whether a user with the received username is authorized to access the computer comprises an instruction to query a database for a record containing the received username and a weak cryptographic hash of a password that is associated with the received username.

22. The computer program product of claim 20, wherein the instruction to retrieve a weak cryptographic hash of a password that is associated with the received username in the computer comprises an instruction to retrieve the weak cryptographic hash of the associated password from the database record.

23. The computer program product of claim 19, wherein the instruction to grant the user access to the computer if the weak cryptographic hash of the received authentication information and the weak cryptographic hash of the authentication information that is stored in the computer are identical comprises an instruction to grant the user access to the computer if the weak cryptographic hash of the received password and the weak cryptographic hash of the associated password are identical.

24. The computer program product of claim 23, further comprising an instruction operable to cause a programmable processor to send the received username and the received password to a remote server if the weak cryptographic hash of the received password and the weak cryptographic hash of the associated password are identical.
